(19) United States
(12) Patent Application Publication
(10) Pub. No.: US 2005/0232420 A1
(43) Pub. Date: Oct. 20, 2005

(54) ATM cell handling

(76) Inventor: Robin E. O'Brien, Ringwood (GB)

Correspondence Address: NIXON & VANDERHYE, PC, 901 NORTH GLEBE ROAD, 11TH FLOOR, ARLINGTON, VA, 22203, US

(21) Appl. No.: 10/052,106

(22) Filed: Jan. 17, 2002

(30) Foreign Application Priority Data
Jan. 23, 2001 (GB) 0101705.2

(51) Int. Cl. H04K 1/00

(52) U.S. Cl. 380/255; 380/287

(57) ABSTRACT

A method of enhancing the resistance of ATM cells (10) to burst errors and jamming, the ATM cells each including a header (12) and payload (11), the method including the step of interleaving the ATM cell header into an error correction transmission frame.

### FIELD OF THE INVENTION

This invention relates to improvements in Asynchronous Transfer Mode (ATM) data transmission systems. More particularly, although not exclusively, this invention relates to techniques and apparatus for enhancing the resistance of ATM data packets (cells) to burst errors originating from link errors and intentional jamming.

### BACKGROUND TO THE INVENTION

Asynchronous Transfer Mode (ATM) is a packet oriented system for transferring digital information based on the use of ATM cells. ATM data is transmitted as a contiguous stream of ATM cells where each cell has a constant length and comprises a header label of 5 bytes and a payload field of 48 bytes (see FIGS. 1a and 1b).

The system is asynchronous in that the cells are identified by means of address information carried in the header label and not by their position in relation to a fixed time reference.

Referring to FIGS. 1a and 1b, the header label includes an address field which- includes the virtual path identifier (VPI) and the virtual channel identifier (VCI). The header label also includes, amongst other things, an 8 bit CRC field for header error control.

The relatively small and constant size of an ATM cell allows ATM hardware to transmit video, audio and data over the same network with rudimentary cell prioritisation being handled by appropriate fields in the header.

A significant problem in many data transmission networks, including ATM systems, is data loss/corruption. This may be in the form of burst errors and can be the result of intrinsic link errors or external error/interference effects which are not dependent on traffic load. An example of as external interference source is jamming. The present invention is primarily concerned with burst error protection and techniques by which resistance to burst errors can be enhanced. This is referred to as “cell hardening” in the present application.

In the case of standard ATM cells, all of the addressing information is carried in the cell header. This makes any ATM cell particularly vulnerable to burst errors or intentional jamming directed at the cell header. Regardless of the subsequent integrity of the payload data, burst or jamming errors may destroy all cell addressing data thus effectively corrupting the entire ATM cell.

The following discussion will be given in the context of tactical networks, specifically those found in military environments. However, this is not to be construed as a limiting application. The present invention may be applied in any environment where increased or enhanced cell transmission reliability is required. Other examples include satellite transmission links and error-prone links carrying different types of traffic such as voice, video and data.

For a tactical network to be effective, some form of error protection must be implemented to avoid unacceptable loss of traffic on high error rate links. High error rates may be the result of burst errors or manmade interference such as jamming. Any attempt to enhance cell resistance to burst errors or jamming should further take into account targeted jamming which attempts to isolate and corrupt the cell header.

Commercial ATM networks usually require link integrities of better that 1 in 10⁷ while tactical links are envisaged to operate in error environments of up to 1 in 10³. There have been a number of attempts to provide improved ATM error correction/handling in error prone transmission environments. The applicants are aware of U.S. Pat. No. 5,699,369 (to Guha) which describes an Adaptive Forward Error Correction Method and System. The technique described in this document is based on deterministic error control intended to recover from congestion-related cell loss. However, the method of Guha requires the determination of whether a specific feasibility condition is met. This is calculated on the basis of an expected number of burst errors in a forward error corrected (FEC) payload and whether forward error correction can compensate for an expected number of burst errors in that encoded payload. However, the technique of Guha does not address the issue of targeted header corruption caused by jamming or burst errors. Guha is concerned primarily with network congestion and can be viewed as a remedial rather than proactive approach to improving ATM cell transmission reliability and enhancing resistance to burst errors.

An aim of the present invention is to provide a method and apparatus that enhances the resistance of an ATM cell to burst errors including man-made interference such as jamming.

### DISCLOSURE OF THE INVENTION

To this end, one aspect of the invention provides a method of enhancing the resistance of ATM cells to burst errors and jamming, the ATM cells each including a header and payload, the method including the step of interleaving the ATM cell header into an error correction transmission frame.

In one preferred embodiment of this aspect of the invention, error correction may be applied separately to the payload and header prior to interleaving them within a transmission frame. Preferably, the error correction corresponds to Reed Solomon forward error correction.

The Reed Solomon encoding may be applied to the header and payload separately following which the encoded header may be interleaved with the encoded payload.

Preferably, empty/idle ATM cells are eliminated/used to substantially match input and output rates of an ATM link.

A further aspect of the invention provides an apparatus adapted to enhance the resistance of ATM cells to burst errors and jamming operation in accordance with the method described herein.

### BRIEF DESCRIPTION OF THE DRAWINGS

The invention will now be described by way of example only and with reference to the figures in which:

FIG. 1: illustrates a prior art ATM cell structure;

FIG. 2: illustrates framing and interleaving applied to an individual ATM cell;

FIG. 3: illustrates a simplified schematic of the architecture of an ATM cell hardening device/unit;

FIG. 4: illustrates a schematic of a simplified portion of an ATM network showing the location of a cell hardening unit/device; and

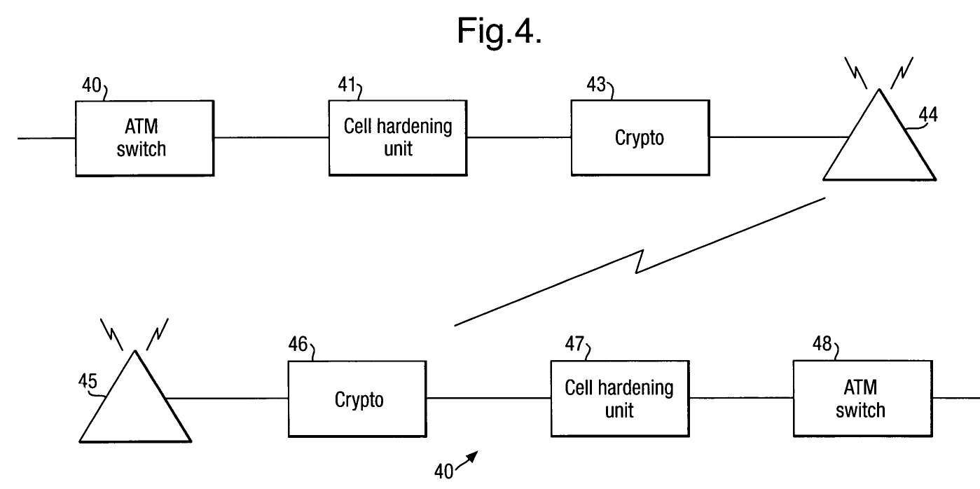

FIG. 5: illustrates a simplified block schematic for a cell hardening device/unit (CHU).

The following discussion will generally relate to ATM transmission of data in error-prone military environments. The cell hardening system described herein is, in one embodiment, intended for protecting ATM trunks being carried over, for example, a radio relay link that is subject to a tactical environment which may include jamming interference, either random or targeting. Other applications are envisaged, such as protecting satellite links.

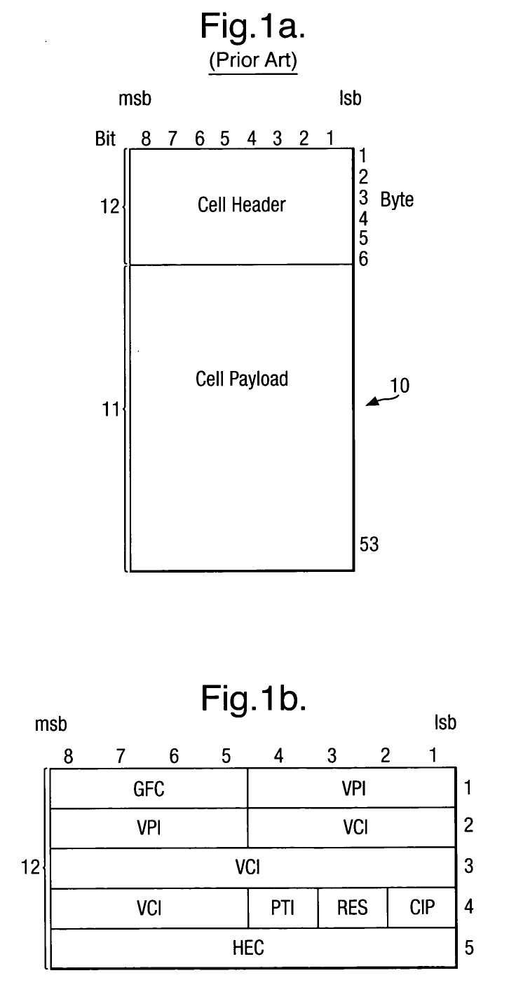

FIG. 1 illustrates a schematic of a prior art ATM packet. ATM packet 10 (hereafter referred to as a cell) consists of a payload field 11 and header 12. The payload 11 is 48 bytes and may correspond to network user information such as data, voice, images etc. The payload 11 can also carry overhead or operations and maintenance information. The header 12 (shown in detail in FIG. 1b includes: an address field (including a VPI: virtual path identifier and VCI: virtual channel identifier) which defines the virtual channel to which the cell is assigned; payload type identifier PTI; an 8-bit CRC field for header error control (HEC), this field also provides the mechanism for cell structure delineation. The location and content of the cell addressing information makes ATM cells potentially susceptible to burst error corruption resulting either from link interference or targeted jamming. In certain situations, it may be possible for a jamming system to determine cell delineation and therefore target specifically the cell header. As noted above, this would effectively destroy the cells contents as, despite retaining the integrity of the payload data, all addressing information would be lost.

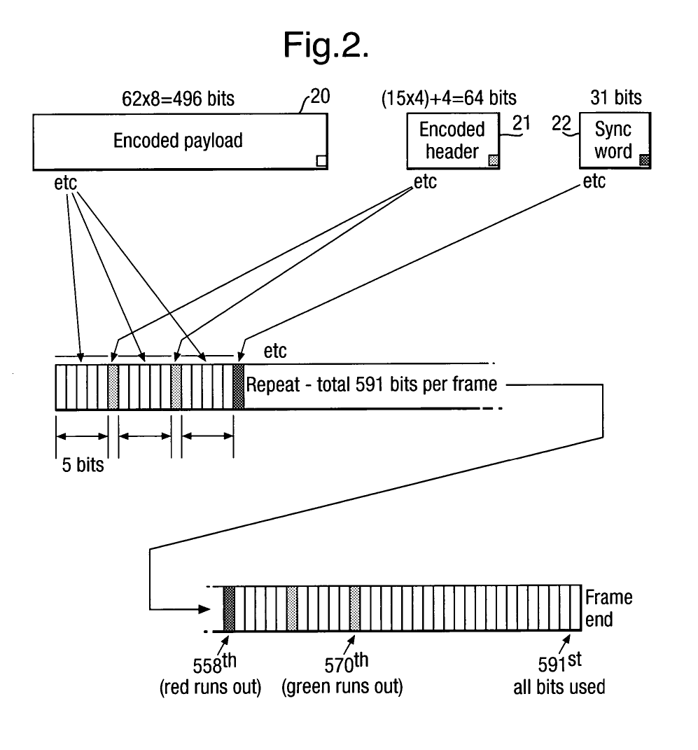

FIG. 2 illustrates a simplified schematic of the cell hardening technique according to one aspect of the invention. The individual ATM cells are encapsulated within an error correction codeword (specifically, two complete Reed Solomon codewords applied to the header and payload as will be discussed below). Therefore if the error correction is overloaded, only a single cell is compromised and error multiplication is avoided. As noted above, within an ATM cell, the header bytes are particularly sensitive in that if they are corrupted, this will cause total loss of the cell. Using knowledge of the header position in conjunction with header encoding, an additional level of protection is provided for. In addition, the header check byte may be replaced by stronger code to achieve additional protection and to identify uncorrectable headers.

As will be discussed below in more detail, additional bits are used in the hardened ATM cell. These extra bits are used to provide extra encoding for the header. They may be derived from idle or unassigned ATM cells, if available, otherwise they contribute to link overheads.

The present invention is considered to provide more robust protection as the header information is interleaved in the entire structure of the cell. This makes the ATM cell more resistant to an attack by a jamming or burst errors as there are no regions of the cell that are particularly vulnerable to attack by an interfering pulse. This is particularly relevant to jamming techniques which look for frame boundaries in order to corrupt the data stream in a systematic way.

Returning to the structure of the hardened ATM cell, FIG. 2 shows the encoded payload 20, encoded header 21 and a 31 bit synchronisation word 32 (where implemented, see Applicants' copending UK patent application [Invention Docket No. XA1294/1295]) interleaved into a contiguous bit stream forming a frame 591 bits in length. Each cell therefore contains two complete Reed Solomon codewords which maximises protection against errors for the shorter, non-payload elements. To this end the sensitivity of the payload data to burst errors may vary depending on the nature of the ATM network user traffic (i.e. voice, data etc.). The hardened ATM cells are then transmitted via the network as ATM cells assembled as described above.

Reed Solomon forward error correction is used as the basic element of the design architecture. This form of encoding was chosen as it provides a good mix of bit error and burst error correction and is relatively straightforward to implement. The specific implementation of Reed-Solomon encoding is considered to be within the purview of the skilled person and will not be discussed in detail herein.

The general operation of such an ATM network is as follows: a standard ATM switch 40 receives ATM cells from a network (not shown). These are passed to a Cell Hardening Unit 41 which processes the cell according to the invention and as described herein. The hardened cells may be subject to cryptographic processes and then transmitted via, for example, an RF link 44/45. The hardened cells are decrypted (if necessary) and decoded as described below. The unpacked cells are then passed to an ATM switch for transmission via the network.

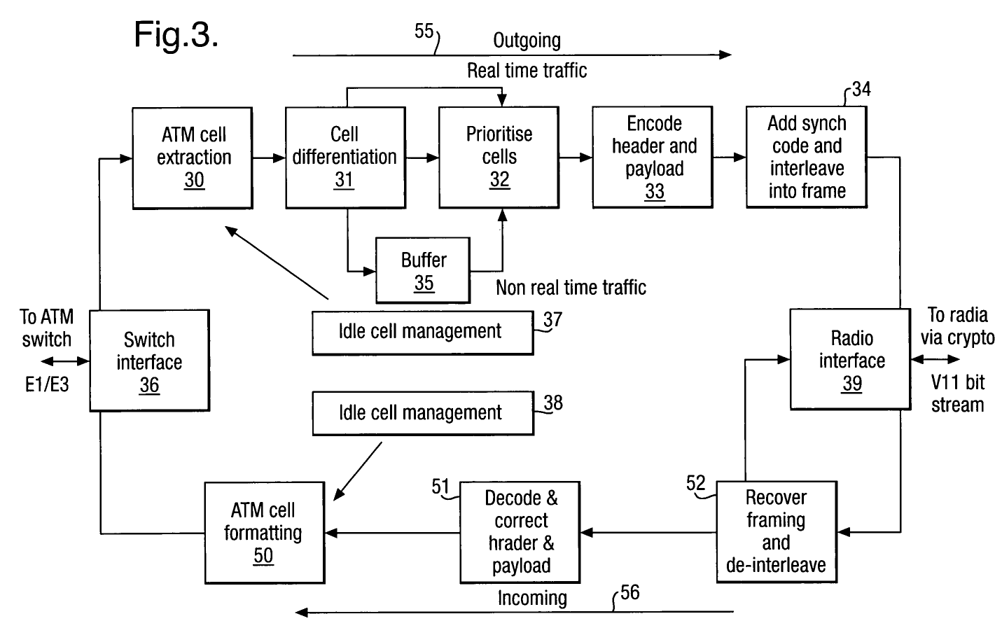

FIG. 3 illustrates a schematic of an illustrative cell hardening device (CHU) architecture. The outgoing path (55) shown in FIG. 3 accepts traffic cells from an ATM switch (not shown). The frame payload is cell delineated (30) while discarding idle and unassigned cells (37). The VPI value of the cell header is then checked (31, 32) to identify the cell as one of the two supported types. If the VPI is odd, then the cell contains voice information and will be given a high priority. If the VPI is even, the cell contains data information and will follow a lower priority route through the CHU.

The cell is then stored in the data or voice buffer (35) as appropriate. Cells are removed from the buffer when the transmitter is able to take them.

By way of rudimentary cell prioritisation, cells in the data buffer are only processed when the voice buffer is empty. Similarly, when both buffers are empty, idle cells are generated and transmitted to maintain the physical link rate of the data connection.

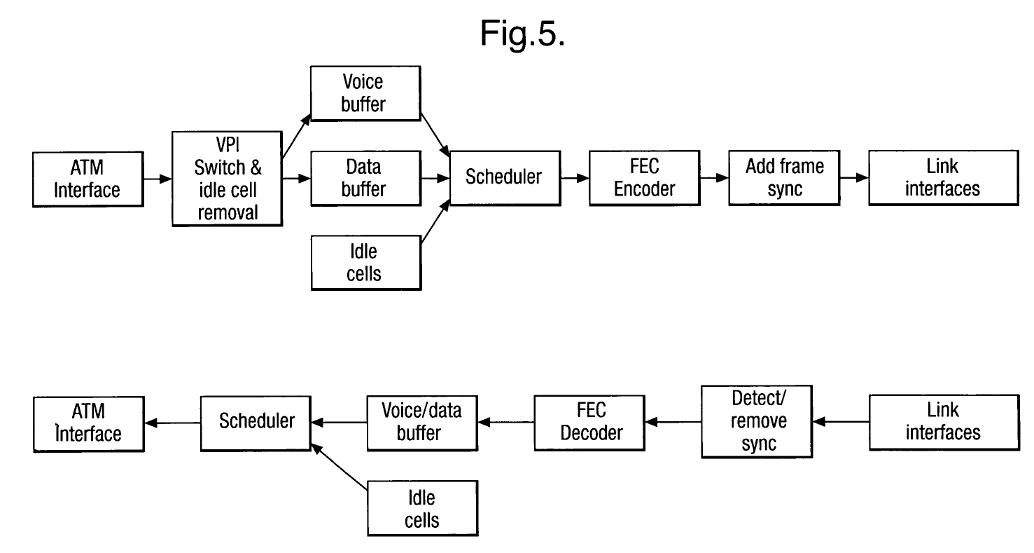

Data cells are not transmitted when the radio interface receiver is out of sync. However voice and idle cells continue to be transmitted when the radio interface is reporting out of sync. According to the operation of a prototype CHU, the cell is then converted into a packed cell by inserting 3 dummy bytes between the cell header and the cell payload. A block schematic of a CHU operating in this manner is shown in FIG. 5. However in the preferred form of the invention and that discussed in detail herein, the three dummy bytes correspond to reserved areas for implementing, amongst other things, header protection etc.

The 56 byte packed cell is then passed to the Reed Solomon encoder (33) for forward error correction encoding. After a processing delay, the FEC packed cell is read from the Reed Solomon encoder and serially clocked out of the CHU at a selectable rate. The series of frames (hardened ATM cells) then leaves the device as a contiguous bit stream which is then sent for transmission on, for example, a radio link (39).

The incoming path (56) shown in FIG. 3 accepts a bit stream of hardened ATM cells from a radio link. The frame delineated cells are converted back into forward error corrected packed cells (52) and passed to the Reed Solomon decoder (51). If the output of the Reed Solomon decoded bitstream contains less than one complete cell, an idle cell is inserted (38). This ensures that a continuous stream of cells is emitted from the CHU interface. The reconstructed ATM cells (50) are then passed to the ATM switch (36).

FIG. 5 illustrates further details of the incoming and outgoing traffic flow which, read in conjunction with FIG. 3 and the description above, shows further details of the cell handling procedure.

In trials, the ATM cell hardening method according to the present invention has been found to yield traffic reliability with link error rates below 1 in 10³. The advantages and viability of the present approach to network traffic protection have thus been amply demonstrated. Unlike previous attempts to enhance the resistance of ATM cells to corruption, the present invention ensures that the cell payload is delivered even when the cell is damaged. Delivering a cell correctly, but with a partially corrupted payload, may be worthwhile in situations where a significant residual error rate can be tolerated. Such an example is in voice communications where the human ear can, to a certain extent, interpolate between breaks and corrupted portions of audio material.

Thus by the invention described herein and the embodiments referred to above, the present invention provides for an ATM cell handling and transmission technique and apparatus which has been shown to have enhanced resistance to burst errors and/or jamming errors. It has further been demonstrated that traffic can reliably be maintained with link error rates below 1 in 10³.

Although the present invention has been described by way of example only and with reference to the possible embodiments thereof, it to be appreciated that improvements and/or modifications may be made thereto without departing from the scope of the invention as set out in the appended claims.

Where in the foregoing description reference has been made to integers or components having known equivalents, then such equivalents are herein incorporated as if individually set forth.

1. A method of enhancing the resistance of ATM cells to burst errors and jamming, the ATM cells each including a header and payload, the method including the step of interleaving the ATM cell header into an error correction transmission frame wherein empty/idle ATM cells are eliminated/used to substantially match input and output rates of an ATM link.

2. A method as claimed in claim 1 wherein error correction is applied separately to the payload and header prior to interleaving them within a transmission frame.

3. A method as claimed in claim 1 wherein the error correction corresponds to Reed Solomon forward error correction.

4. A method as claimed in claim 3 wherein the Reed Solomon encoding is applied to the header and payload separately following which the encoded header is interleaved with the encoded payload.

5-6. (canceled)

7. An apparatus adapted to enhance the resistance of ATM cells to burst errors and jamming operation in accordance with the method of claim 1.
